(19) United States
(12) Patent Application Publication
(10) Pub. No.: US 2016/0292735 A1
(43) Pub. Date: Oct. 6, 2016

(54) APPARATUS AND METHOD FOR CUSTOMIZED COUPON PROVIDING SERVICE

(71) Applicant: SK PLANET CO., LTD., Seongnam-si (KR)

(72) Inventor: Jongho KIM, Gwacheon-si (KR)

(21) Appl. No.: 15/077,581

(22) Filed: Mar. 22, 2016

(30) Foreign Application Priority Data
Mar. 30, 2015 (KR) 10-2015-0044013

(51) Int. Cl. G06Q 30/02

(52) U.S. Cl. CPC G06Q 30/0257; G06Q 30/0259; G06Q 30/0267

(57) ABSTRACT

A current position of a user is compared with a predetermined main residential area and a main travel path, an event-identification target is determined depending on deviation of the current position such that coupon information of an affiliated store around the current position of the user is searched and provided if the current position deviates from the main residential area and the main travel path and coupon information of an affiliated store around the current position having been previously used is searched and provided based on utilization information history of the user if the current position does not deviate from the main residential area and the main travel path, that is, the user exists within the main residential area and the main travel path, thereby enabling effective purchase and inducing the user to use an affiliated store that provides a coupon.

### CROSS-REFERENCE TO RELATED APPLICATION

This application claims priority to and the benefit of Korean Patent Application No. 10-2015-0044013 filed in the Korean Intellectual Property Office on Mar. 30, 2015, the entire contents of which are incorporated herein by reference.

### TECHNICAL FIELD

The present invention relates to an apparatus and a method for customized coupon providing service, and more particularly, to an apparatus and a method for a customized coupon providing service capable of collecting information of a user about using an affiliated store and current position information about the user, determining a possibility of purchase at the current point of time based on the collected current position information and the collected utilization information about using an affiliated store, and providing a coupon related to corresponding position information according to the possibility of purchase.

### BACKGROUND

The statement in this section merely provides background information related to the present invention and does not necessarily constitute a related art.

As a part of advertisement marketing, various coupons, such as a discount ticket, a complimentary ticket, an exchange ticket, and the like are provided to stimulate or promote purchasing incentive and interests of a consumer. Such a coupon providing service has been periodically provided to members or randomly provided to unspecified individuals.

As for the coupon providing service, due to lacking a consideration of the time at which coupons are needed, a user has difficulty in using a coupon when the coupon is needed, and due to the random dispatch to unspecified individuals, the coupons end up being issued even for the people who do not have a possibility to use the dispatched coupons, which causes waste of resources and degrades reliability of customers.

In order to reduce the above constraints, there is provided a customized coupon service in which a product or service that is likely to attract a user's interest is predicted based on the user's payment history or user's profile and a coupon is provided. However, the customized coupon service is performed by providing a coupon in a product group or a service group similar to a product or a service that has been previously purchased by a user, or by providing a coupon of a product group or a service group of the highest interest in an age group, a gender group and a career group corresponding to the user, based on age, gender and career specific statistical information, which does not show high precision in matching to the user's interest and is also insufficient for satisfying all users' demands

### Prior Art Document

Korean Patent Publication No. 10-2005-0092682, published on Sep. 22, 2005 (Title: The method of offering interactive coupon service by using the mobile communication device).

### SUMMARY

The present invention is directed to providing an improved coupon providing service, providing a coupon providing server and a coupon providing method for a customized coupon proving service that is capable of determining a possibility of purchase at the current point of time based on information about a user about using an affiliated store and information about a current position of the user, and if the possibility of purchase is determined to be strong, providing a coupon based on the current position of the user.

One aspect of the present invention provides a coupon proving server including a storage module, a user information collecting module, an event processing module, and a coupon service module. The storage module may be configured to store position information about a main residential area of a user and position information about a main travel path of the user, information of the user about using an affiliated store, information about a coupon usable at each affiliated store and information about an event being in progress at each affiliated store. The user information collecting module may be configured to collect real-time position information about the user, position information about a main residential area of the user, position information about a main travel path of the user and utilization information of the user about using an affiliated store. The event processing module may be configured to, upon receiving an information request message including current position information about the user from the user, compare the current position information with the main residential area and the main travel path, and if it is determined that the user is out of the main residential area and the main travel path, determine that the current position information as an event-identification target. The coupon service module may be configured to, in response to the information request message, search for coupon information of an affiliated store related to the current position determined as the event-identification target, generate an information request responding message including the searched coupon information and provide the user terminal with the generated information request responding message.

The event processing module may compare the current position information with the main residential area and the main travel path, and if it is determined that the user is not out of the main residential area and the main travel path, determine the utilization information of the user related to the current position information as an event-identification target. The coupon service module may search for coupon information of an affiliated store that is related to the current position information and has been used by the user, based on the utilization information.

Another aspect of the present invention provides a method for customized coupon providing service, the method including: collecting position information about a user in real time or periodically; extracting and storing information about a main residential area and a main travel path of the user based on the collected position information; checking whether a current position of the user deviates from the main residential area and the main travel path by comparing the current position information of the user with the main residential area and the main travel path; and sending a coupon providing apparatus an information request message to request coupon information related to the current position information if it is determined that the collected current position deviates from the main residential area and the main travel path.

The method may further include: collecting information of the user about using affiliated stores; and sending the coupon providing apparatus an information request message to request coupon information related to utilization information related to the current position information if it is determined that the collected current position does not deviate from the main residential area and the main travel path.

Still another aspect of the present invention provides a method for a customized coupon providing service, the method including: collecting position information about an affiliated store, information about a coupon usable in the affiliated store and information about an event being in progress in the affiliated store from one or more affiliated store terminals and storing the collected information; setting a main residential area and a main travel path of a user; receiving an information request message including current position information from one or more user terminals; comparing the received current position information with the main residential area and the main travel path, and determining the received current position information as an event-identification target if it is determined that the current position deviates from the main residential area and the main travel path; searching for coupon information of an affiliated store around the current position that is determined as the event-identification target; and transmitting an information request responding message including the searched coupon information to the one or more user terminals.

The method may further include: collecting information of a user about using affiliated stores; comparing the received current position information with the main residential area and the main travel path, and determining utilization information related to the received current position information as an event-identification target if it is determined that the user has not deviated from the main residential area and the main travel path; and searching for coupon information of an affiliated store that is related to the received current position information and has been used by the user, based on the utilization information that is determined as the event-identification target.

In the setting of the main residential area and the main travel path, a main residential area and a main travel path of the user may be extracted by analyzing position information having been collected from the user terminal for a predetermined period of time.

Yet another aspect of the present invention provides a computer-readable recording medium recording a program to execute the method for a customized coupon providing service described above.

As is apparent from the above, according to the present invention, a possibility of purchase at the current point of time is determined based on information about a user about using an affiliated store and information about a current position of the user, and if the possibility of purchase is determined to be strong, a coupon is provided based on the current position of the user, thereby providing the user with an optimized coupon at the current point of time and the current position of the user, and thus supporting an effective purchase of the user.

In addition, according to the present invention, a coupon is provided to a user who is high likely to use an affiliated store, so that waste of recourse and degradation of reliability of customers due to undiscriminating dispatch of coupons can be prevented and a possibility of a coupon being used can be increased, thereby inducing a user to use a corresponding affiliated store, leading to increase in the sales of the affiliated store.

### BRIEF DESCRIPTION OF DRAWINGS

FIG. 1 is a view schematically illustrating a whole network of a coupon providing system according to an exemplary embodiment of the present invention.

FIG. 2 is a view illustrating a configuration of a user terminal in a coupon providing system according to an exemplary embodiment of the present invention.

FIG. 3 is a view illustrating a detailed configuration of a user terminal in a coupon providing system according to an exemplary embodiment of the present invention.

FIG. 4 is a view illustrating a detailed configuration of a coupon providing server in a coupon providing system according to an exemplary embodiment of the present invention.

FIG. 5 is a view showing a coupon providing service procedure in a coupon providing system according to a first exemplary embodiment of the present invention.

FIG. 6 is a view showing an example of a method of providing a coupon in a user terminal of a coupon providing system according to the first exemplary embodiment of the present invention.

FIG. 7 is a view showing another example of a method of providing a coupon in a user terminal of a coupon providing system according to the first exemplary embodiment of the present invention.

FIG. 8 is a view showing a method of providing a coupon in a coupon providing server of a coupon providing system according to the first exemplary embodiment of the present invention.

FIG. 9 is a view showing a personal customized coupon providing service procedure in a coupon providing system according to a second exemplary embodiment of the present invention.

FIG. 10 is a view showing a method of providing a coupon in a user terminal of a coupon providing system according to the second exemplary embodiment of the present invention.

FIG. 11 is a view showing a method of providing a coupon in a coupon providing server of a coupon providing system according to the second exemplary embodiment of the present invention.

### DETAILED DESCRIPTION

The above and other advantages, and a scheme for the advantages of the present invention will become readily apparent by reference to the following detailed description when considered in conjunction with the accompanying drawings.

In the description of the embodiment, the detailed description of related known functions or configurations will be omitted herein to avoid making the subject matter of the embodiment ambiguous. In addition, like numbers refer to like elements throughout the description of the figures.

It should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the embodiments set forth herein and illustrated in the configuration of the present invention are nothing but the most preferred embodiment only and do not represent all the technical spirit of the present invention, so that it should be understood that various equivalents and modifications can replace them.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “ adjacent” versus “directly adjacent”, etc.).

The terminology used herein is for the purpose of describing particular embodiments only and is not intended to be limiting of the invention. As used herein, the singular forms “a,” ^{an} _{and} ^{the} are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Exemplary embodiments of the present invention may include a computer-readable medium that includes or transmits a computer executable instruction or a data structure stored in the computer-readable medium. The computer-readable medium may be a random available medium that allows access of a universal or specific purpose computer system. For example, the computer-readable medium may include a physical storage medium: such as RAM, ROM, EPROM, CD-ROM or other optical disk storage devices, a magnetic disk storage device or other magnetic storage devices, or other media that are used to store or transmit a computer-executable instruction, a computer-readable instruction or a predetermined program code means in a data structure and are accessed by a universal or specific purpose computer system.

In the following description and claims, “coupon” represents a complimentary ticket, a pass and a discount ticket that are issued and provided from an online/offline affiliated store and submitted to a corresponding online/offline affiliated store to use a certain service or product for free or at a discounted price. According to the present invention, the coupon in the present invention is provided in the form of an electronic data such as a text message, a multimedia message, an image, and one-dimensional/two-dimensional codes, such as a barcode and a QR code.

The present invention is provided to determine a possibility of purchase at the current point of time based on information of a user about using an affiliated store and current position information about the user, and if it is determined that the possibility of purchase is strong, provide a coupon related to the current position of the user at the current point of time. The present invention may be implemented in a network computing environment having various types of computer system configurations including a personal computer, a laptop computer, a handheld device, a multiprocessor system, a microprocessor-based or programmable consumer electronics, a network PC, a mini computer, a main frame computer, a mobile phone, a PDA, a pager, and the like.

The present invention may be implemented in a distributed system environment in which a local computer system and a remote computer system that are linked in a wired data link, a wireless data link, or a combination of wired data link and wireless data link through a network perform tasks. In the distributed system environment, program modules may be located in a local memory storage device and a remote memory storage device.

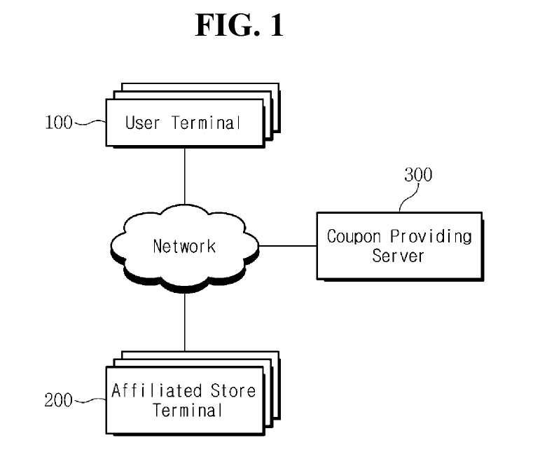

FIG. 1 is a view schematically illustrating a whole network of a coupon providing system according to an exemplary embodiment of the present invention.

Referring to FIG. 1, a coupon providing system includes one or more terminals 100, one or more affiliated store terminals 200 and a coupon providing server 300 that are connected to each other via a network.

The one or more user terminals 100, the one or more affiliated store terminals 200 and the coupon providing server 300 interoperate with each other through the network. For reference, the “network” is defined as one or more data links that allow electronic data transmission between computer systems and/or modules. When information is transmitted or provided to a computer system through network or other communication access (wired scheme, wireless scheme or combination of wired/wireless schemes), the access may be taken as a computer-readable medium. A computer-readable instruction may include an instruction and data that allow a universal computer system or a specific purpose computer system to perform a certain function or a group of functions. The computer-executable instruction may include an assembly language or binary, intermediate format instructions, such as source codes.

The network according to the present invention may be provided using a wireless communication scheme, such as Wireless LAN (WLAN), Wi-Fi, Wibro, Wimax, High Speed Downlink Packet Access (HSDPA). The network is not limited thereto, and may be implemented in a wired communication scheme, such as Ethernet, xDSL (ADSL, VDSL), Hybrid Fiber Coaxial Cable (HFC), Fiber to The Curb (FTTC), Fiber To The Home (FTTH) according to implementation of a system.

In addition, the network may include a plurality of access networks and a core network, and add an external network, for example, an Internet network. The access network is an access network to perform a wired/wireless communication with the terminal 100. For example, the access network may be implemented using a plurality of base stations, such as Base Station (BS), Base Transceiver Station (BTS), NodeB, and eNodeB, and a base station controller, such as a Base Station Controller (BSC) and a Radio Network Controller (RNC). In addition, a digital signal processor and a wireless signal processor integrated with each other in the base station as described above may be separated into a digital unit (hereinafter, referred to as DU) and a radio unit (hereinafter, referred to as RU), such that a plurality of RUs are installed in a plurality of areas and are connected to a centralized DU.

In addition, a core network constituting a mobile network together with an access network may serve to connect the access network to an external network, for example, an Internet network.

The core network is a network system to perform a main function for a mobile communication service, such as control of mobility and switching between access networks as described above. The core network performs a circuit switching or a packet switching, and manages and controls a packet flow in a mobile network. In addition, the core network (not shown) serves to manage mobility between frequencies and perform interworking with respect to traffic in the access network (not shown) and the core network (not shown) and other networks (for examples, an Internet network (not shown). The core network (not shown) may further include Serving GateWay (SGW), PDN GateWay (PGW), Mobile Switching Center (MSC), Home Location Register (HLR), Mobile Mobility Entity (MME) and Home Subscriber Server (HSS).

In addition, the Internet network (not shown) represents a general open communication network in which information is exchanged according to TCP/IP protocols, that is, a public network. The Internet network is connected to the affiliated store terminal 200, and provides information provided from the affiliated store terminal 200 to the user terminal 100 via the core network (not shown) and the access network (not shown) and may provide information provided form the user terminal 100 to the affiliated store terminal 200 via the access network (not shown) and the core network (not shown).

In addition, the network may a short-range communication network built based on Wi-Fi, Bluetooth Low Energy (BLE), Zigbee, ultrasound, etc.

The network according to the present invention may include generally known communication schemes and communication schemes to be developed in the future in addition to the above described communication schemes.

The user terminal 100 may transmit and receive data according to a customized coupon providing service by accessing the coupon providing server 300 through the above described network. For example, the user terminal 100 may transmit position information about a user or event information based on the position to the coupon providing server 300, and may receive a customized coupon extracted based on the position information or event information from the coupon providing server 300.

The user terminal 100 may be implemented as an electronic device that may be able to transmit various types of data via a network according to a user's key manipulation. To this end, the user terminal may include a computing environment that includes a memory to store a program and a protocol and a microprocessor to perform operation and control by executing various types of programs.

For example, the user terminal 100 may be implemented using one of a tablet PC, a laptop, a personal computer (PC), a smartphone, a personal digital assistant (PDA), a smart TV and a mobile communication terminal.

The affiliated store terminal 200 according to the present invention is an apparatus used by a user of an affiliated store, and is configured to send the coupon providing server 300 coupon and event information to be provided to a corresponding affiliated store via a network, and perform information update about transmitting the coupon and event information.

The affiliated store terminal 200, similar to the user terminal 100, may be implemented as an electronic device to perform a data communication by using a network, that is, a computing system provided with a browser to communicate with the coupon providing server 300 via a network, a memory to store a program and a protocol and a microprocessor to perform operation and control by executing various types of programs. For example, the affiliated store terminal 200 may be a POS terminal having a payment processing function or a common user device, such as a tablet PC, a laptop, a personal computer (PC), a smartphone, a personal digital assistant (PDA), smart TV and a mobile communication terminal

The coupon providing server 300 is a server apparatus that performs a customized coupon providing service based on a network, while interworking with one or more user terminals 100 and one or more affiliated store terminals 200 to transmit and receive an application (or a program) for a distinguished personal customized coupon providing service and relevant data.

In detail, the coupon providing server 300 may perform a customized coupon providing service procedure by receiving and storing position information about an affiliated store and coupon and event information from the affiliated store terminal 200 through a network, and determining whether to provide a coupon of an affiliated store corresponding to the position information of a user provided from the user terminal 100 through a network, and thus may provide the user terminal 100 with a position of an affiliated store and a coupon available for use.

In addition, the coupon providing server 300 according to the present invention, upon receiving position information about a user from the user terminal 100, may determine a possibility of purchase at a current position based on the received position information about the user and utilization information of the user, and if it is determined that the possibility of purchase is strong, may provide the user terminal 100 with information about an affiliated store around the current position information of the user, information about a coupon available in the corresponding affiliated store and information about an event in progress in the corresponding affiliated store.

Hereinafter, configurations of a user terminal and a coupon providing server according to an exemplary embodiment of the present invention in the coupon providing system described above will be described in detail with reference to accompanying drawings.

Prior to detailed description of configuration and operation of the coupon providing system according to the present invention, a computing environment in which a configuration and an operation according to the present invention are achieved will be described.

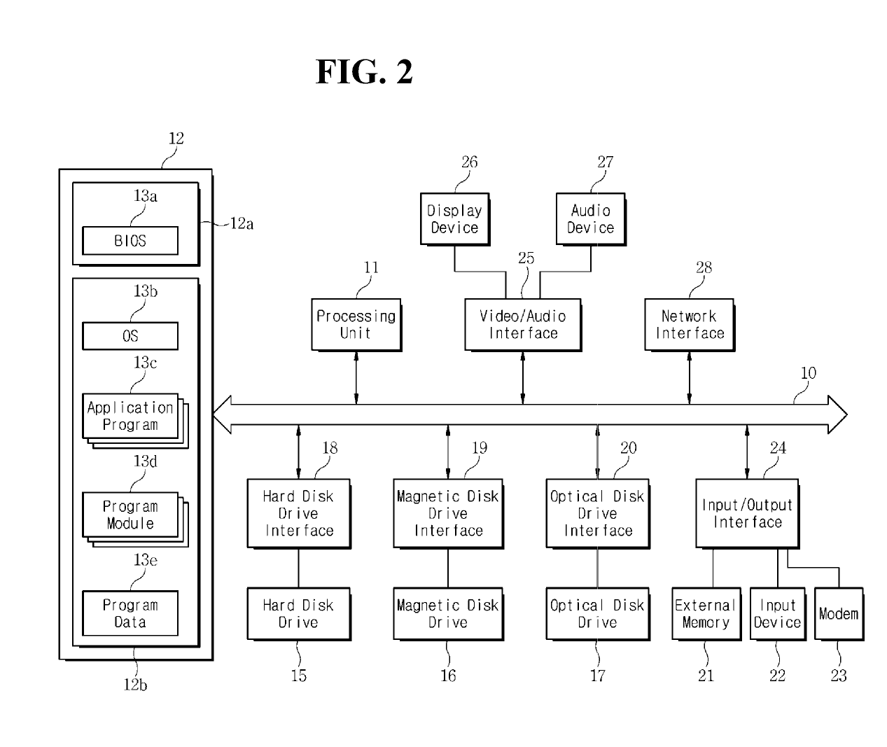

The user terminal 100, the affiliated store terminal 200 and the coupon providing server 300 according to the present invention are constructed and operated based on a computing system described in FIG. 2.

FIG. 2 or below provides schematic and general description on a computing environment suitable for implementing the present invention. If needed, the present invention will be described on a computer executable instruction, such as a program module executed by a computer system. In general, a program module includes a routine, a program, an object, a component and a data structure that performs a certain task or implements a certain abstract data type. The computer executable instruction, relevant data structure and relevant program module are provided as an example of a program code means that executes the disclosed present invention disclosed in this specification.

Referring to FIG. 2, the computing system according to an exemplary embodiment of the present invention includes a computing apparatus including a processing unit 11, a system memory 12 and a system bus 10 to connect various system components including the system memory 12 to the processing unit 11.

The processing unit 11 may execute a computer executable instruction designed to implement the features of the present invention.

The system bus 10 may be implemented by one of a local bus, a peripheral bus and a memory bus, which may use any one of various bus architectures, or several types of bus structures, which include a memory controller. The system memory 12 includes a Read Only Memory (ROM) 12a and a Random Access Memory (RAM) 12b. In general, a basic input/output system (BIOS) 13a that includes a basic routine assisting transmission of information between components in the computing system at the time of start may be stored in the ROM 12a.

The computing system may include a storage medium, for example, a hard disk drive 15 to read information from a hard disk or record information in the hard disk, a magnetic disk drive 16 to read information from a magnetic disk or record information in the magnetic disk, and an optical disk drive 17 that reads information from an optical disk, such as a CD-ROM or other optical media or record information in the optical disk. The hard disk drive 15, the magnetic disk drive 16 and the optical disk drive 17 are connected to the system bus 10 by a hard disk drive interface 18, a magnetic disk drive interface 19 and an optical drive interface 20, respectively.

In addition, the computing system may be further provided with an external memory 21 as a storage medium. The external memory 21 may be connected to the system bus 10 through an input/output interface 24.

The above described drives and relevant computer readable media read and recorded by the drives provide non-volatile storing of computer executable instructions, data structures, program modules and other data. Although the hard disk, the magnetic disk and the optical disk are illustrated as a non-volatile storage medium in the exemplary environment described in this specification, the present invention is not limited. For example, other types of computer readable media that store data, for example, a magnetic cassette, a flash memory card, DVD, RAM, ROM may be used.

A program code means including one or more program modules and loaded and executed by the processing unit 11 may be stored in the hard disk, the magnetic disk and the optical disk, the ROM 12a and the RAM 12B, the program code means including an operating system 13b, one or more application programs 13c, other program modules 13d and program data 13e.

In addition, the computing system may receive an instruction and information from a user through various input device 22, such as a keyboard, a pointing apparatus, a microphone, a joystick, a game pad, a scanner, etc. The input device 22 may be connected to the processing unit 11 through the input/output interface 24 connected to the system bus 10. For example, according to the input/output interface 24, a certain one of a serial port interface, a PS/2 interface, a parallel port interface, a USB interface, Institute of Electrical and Electronics Engineers (IEEE) 1394 interface, that is, a FireWire interface or a combination thereof may be represented in a logical manner.

In addition, the computing system to which the present invention is applied may further include a display device 26, such as a monitor or a LCD or an audio device 27 such as a speaker or a microphone, which are connected to the system bus 10 through a video/audio interface 25. For example, other peripheral output apparatus, such as a speaker and printer (not shown) may be connected to the computer system The video/audio interface 25 may include a High Definition Multimedia Interface (HDMI) and Graphics Device Interface (GDI).

In addition, the computing system for executing the present invention, may access a network, such as a wide area network (WAN), home network, intranet and/or the Internet. The computer system may exchange data with external sources, such as a remote computer system, a remote application and/or a remote database, through the network.

To this end, the computing system to which the present invention is applied includes a network interface 28 for receiving data from and transmitting data to an external source.

The network interface 28 may be represented in a logical combination of one or more software and/or hardware modules, such as a network interface card and a network driver interface specification (NDIS) stack corresponding thereto. The network interface 28 may support various communication protocols, for example, various mobile communication standards, such as AMPS, CDMA, GSM, W-CDMA, HSDPA, LTE, LTE-A, etc. and may support short range wireless network technology such as BLE and Zigbee.

Similarly, the computer system receives data from an external source or transmits data to an external source through the input/output interface 24. The input/output interface 24 may be connected to a modem 23 (for example, a standard modem, a cable model or a digital subscriber line (DSL) modem), and through the modem 23, may receive data from an external source and/or transmit data to an external source through the modem 23.

FIG. 2 illustrates an operating environment in which the present invention is performed, but if necessary, the operating environment may be appropriately modified so as to be adopted by any other system in which the concept of the present invention can be implemented. The environment shown in FIG. 2 is for illustrative, and represents only a part of various environments in which the concept of the present invention can be implemented.

The configuration and function according to the present invention is implemented as a program, and stored in a computer readable storage medium related to the computing system shown in FIG. 2. For example, a part of program modules and relevant program data to perform functions according to the present invention may be included in the operating system 13b, the application program 13c, the program module 13d and/or the program data 13e.

In addition, when a mass storage device, such as a hard disk is connected to the computing system, the program module and relevant program data may be stored in the mass storage device. In a network environment, a program module to perform the functions of the present invention or a part thereof may be stored in a system memory of a remote computer system connected through the modem 23 of the input/output interface 24 or the network interface 28, for example, a system memory of the computing system of the user terminal 100 or the affiliated store terminal 200 and/or in a remote memory storage device such as a mass storage device. Executing such a module may be performed in a distributed computing environment described above.

Hereinafter, configuration of apparatuses according to an exemplary embodiment of the present invention in the coupon providing system implemented based on the above described computing system will be described with reference to the accompanying drawings in detail. ‘A module’ constituting each apparatus to be described below represents a component implemented as software, hardware or a combination thereof to perform a predetermined function. For example, a module may be a program module stored in a storage media of a computing system shown in FIG. 2, and may be executed by the processing unit 11.

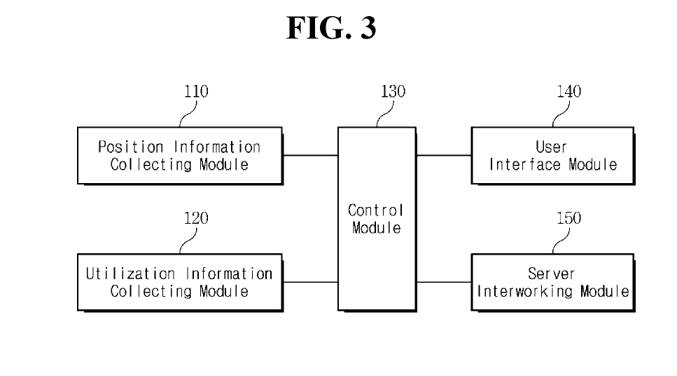

FIG. 3 is a view illustrating a detailed configuration of the user terminal 100 in a coupon providing system according to an exemplary embodiment of the present invention.

Referring to FIG. 3, the user terminal according to the present invention includes a position information collecting module 110, a utilization information collecting module 120, a user interface module 140, and a server interworking module 150.

The position information collecting module 110 is configured to collect position information about the user terminal 100 in real time. The position information collecting module 110 may collect position information about the user terminal 100 by receiving a satellite signal based on a Global Positioning System (GPS) technology, and by further using a short range communication technology such as Wi-Fi, Zigbee, UWB, Bluetooth, BLE, RFID, or a mobile communication technology, may collect the position information. To this end, the position information collecting module 110 may interwork with the network interface 28 of the computing system as shown in FIG. 2. For reference, the position information collecting module 110 may use Cell-ID, trigonometry, and fingerprinting to collect position information.

The utilization information collecting module 120 is configured to collect information of a user about using a product or service, for example, details of purchase. For example, the utilization information may be extracted from a text message and an instant message received by the user terminal 100.

A control module 130 is configured to control an overall processing of the coupon providing service according to the present invention, and performs a customized coupon service according to the present invention while operating in association with the position information collecting module 110, the utilization information collecting module 120, the user interface module 140 and the server interworking module 150.

In detail, according to the first exemplary embodiment of the present invention, the control module 130 controls the position information collecting module 110 to collect position information in real time, and controls the utilization information collecting module 120 to periodically collect information of a user about using a product or service. The control module 130 may extract position information about a main residential area of a user and information about a main travel path of the user from position information that have been collected for a predetermined period of time, and may extract a trading area that is used by the user (hereinafter, referred to as trading area use information) based on the utilization information of the user about using a product or service collected through the utilization information collecting module 120. In addition, upon completing the extracting of the position information about the main residential area/information about the main travel path and the trading area use information, the control module 130 may determine a possibility of a purchase at the current point of time at the current position based on the extracted information. For example, a possibility of purchase may be determined depending on whether a current position deviates from the main residential area/the main travel path or the trading area. That is, when position information of an area (a trading area) that is not frequently visited by a user at normal times is collected, it is considered that an intention to purchase a certain product or service in the area is high. When the control module 130 determines that there is a possibility of purchase, the control module 130 may control the server interworking module 150 to send the coupon providing server 300 an information request message to request a customized coupon providing service with respect to the corresponding position information.

In addition, the control module 130, upon receiving the information request responding message from the coupon providing server 300, may control the user interface module 140 to provide the user with coupon information included in the received information request responding message.

The user interface module 140 is configured to output information or to recognize a user's input by interworking with the input/output apparatus of the computing system shown in FIG. 2, that is, the input device 22, the display device 26, and the audio device 27. For example, the user interface module 140 forms a GUI screen to output coupon information and outputs the GUI screen to the display device 26, and recognizes a command represented by a user input signal input from the input device 22 and transmits the recognized command to the control module 130.

The server interworking module 150 is configured to perform a processing for interworking with the coupon providing server 300, by generating an information request message and transmitting the generated information request message through the network interface 28 and on the contrary by checking an information request responding message received through the network interface 28 and processing the information request responding message.

Meanwhile, according to the second exemplary embodiment of the present invention, the control module 130 may simply transmit the information request message including the collected position information to the coupon providing server 300 through the server interworking module 150, and upon receiving an information request responding message from the coupon providing server 300, may transmit coupon information included in the received information request responding message to the user interface module 140 such that the coupon information is displayed.

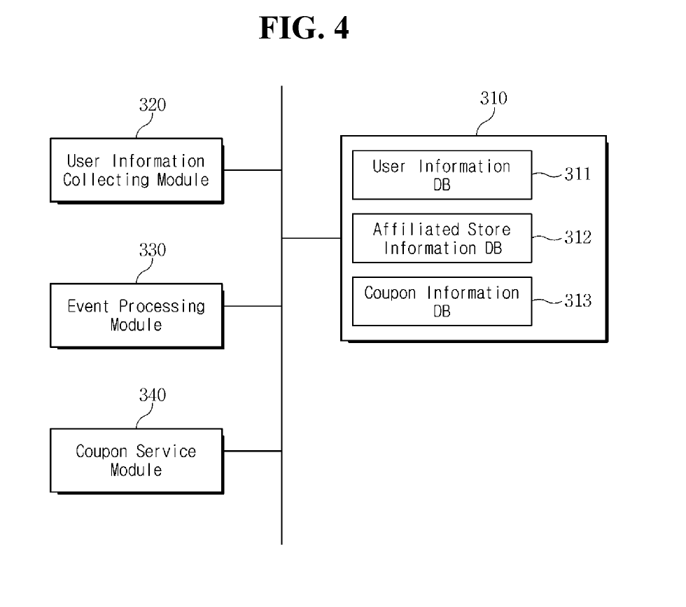

FIG. 4 is a view illustrating a detailed configuration of the coupon providing server 300 in a coupon providing system according to an exemplary embodiment of the present invention.

Referring to FIG. 4, the coupon providing server 300 according to the exemplary embodiment of the present invention includes a storage module 310, a user information collecting module 320, an event processing module 330 and a coupon service module 340.

The storage module 310 is configured to store information with respect to providing a personal customized coupon providing service, and may include at least a user information DB 311, an affiliated store information DB 312, and a coupon information DB 313.

The storage module 310 is configured to store and manage information, and may represent a database system that may be stored in a storage medium, for example, the system memory 12, hard disk, magnetic disk, optical disk and the external memory 21 shown in FIG. 2.

According to the present invention, the storage module 310 may include the user information DB 311, the affiliated store information DB 312, and the coupon information DB 313.

The user information DB 331 according to the present invention stores and manages information (hereinafter, referred to as user information) related to a user who receives a personal customized coupon providing service (for example, a user who has subscribed to a service). For example, the user information may include information with which a user is identified, for example, a name and a phone number, position information about a main residential area and a main travel path, utilization information, and coupon and event information details that have been provided according to a personal customized coupon providing service.

The affiliated store information DB 332 according to the present invention stores information related to an affiliated store which is associated with a personal customized coupon providing service, and for example, the affiliated store information may include information with which an affiliated store is identified, for example, a name, a category of business, a phone number, an address, and a business registry number, and may include information with which at least position information about an affiliated store is identified.

The coupon information DB 333 according to the present invention may store a coupon available at each affiliated store, and information about an event in progress at each affiliated store. The coupon information may be updated in association with the affiliated store terminal 200.

The user information collecting module 320 according to the present invention may collect position information and utilization information about a user that are collected from the user terminal 100 in real time. In addition, the user information collecting module 320 may extract at least one of a main residential area, a main travel path of a user and a trading area being used the user by analyzing the collected position information and utilization information of the user. The collected and extracted information may be stored in the user information DB 311 of the storage module 310.

The coupon service module 340 receives an information request message including position information about a user, and based on the received position information about the user, searches for information about a relevant affiliated store and coupon information available in the relevant affiliated store, and provides the user terminal 100 with an information request responding message including the searched information.

To this end, the coupon service module 340 may receive position information about an affiliated store for the customized coupon providing service, information about a coupon available for use in the affiliated store and information about events in progress from the affiliated store terminal 200 and store the received information in the storage module 310.

Meanwhile, according to the second exemplary embodiment of the present invention, the coupon providing server 300, prior to providing a coupon through the coupon service module 340, analyzes a possibility of a user's purchase through the event processing module 330, and determines whether to provide a coupon service depending on the possibility of purchase . In detail, the event processing module 330 checks whether the current position of the user deviates from the main residential area/main travel path collected through the user information collecting module 320, and if it is determined as deviation, may determine that there is a strong possibility of purchase, and determine the corresponding position as an event-identification target. On the contrary, if it is not determined as deviation, the event processing module 330 may determine previous utilization information as an event-identification target.

In this case, the coupon service module 340, if there is a possibility of purchase, searches for a coupon of an affiliated store related to position information about a user, and provides the user terminal 100 with the result of search. For example, the coupon service module 340 refers to an affiliated store around a position corresponding to the position information about a user that is determined as an event-identification target, searches for information about a coupon available for use in the affiliated store referred to and information about an event in progress in the affiliated store, and provides the user terminal 100 with the searched result.

On the other hand, the coupon service module 340, if the current position of the user does not deviate from the main residential area/main travel path, searches for a coupon of a relevant affiliated store based on previous utilization information, and provides the user terminal 100 with the searched result. That is, the coupon service module 340 may provide a user with a coupon of an affiliated store existing around the current position of the user and previously used by the user.

Hereinafter, a method for a personal customized coupon providing service in the coupon providing system constituted as the above will be described in detail with reference to the accompanying drawings. First, a procedure for providing a personal customized coupon providing service in a coupon providing system according to the first exemplary embodiment of the present invention will be described.

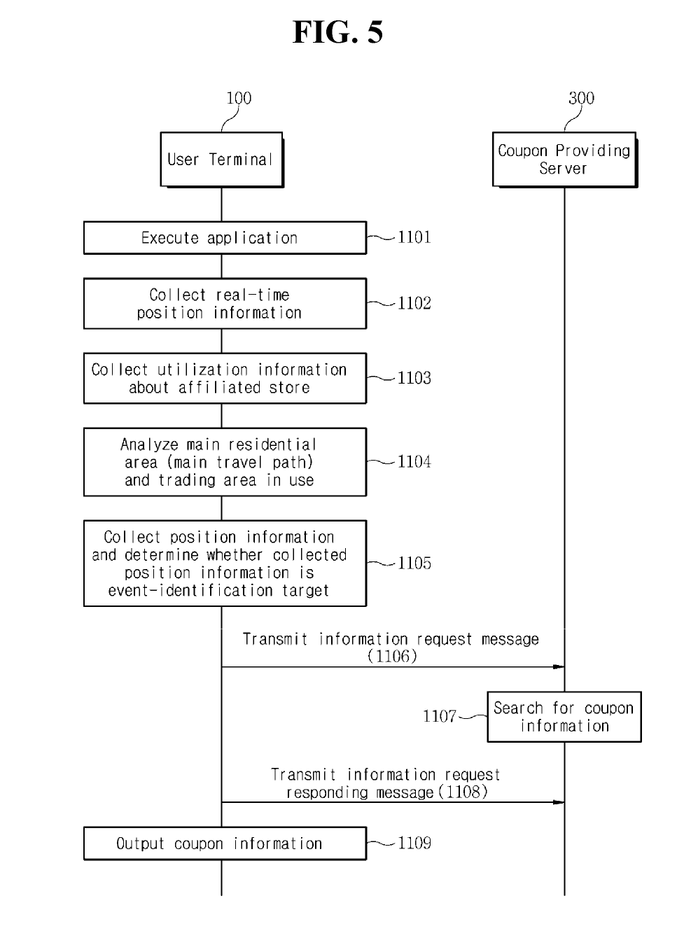

FIG. 5 is a view showing a coupon providing service procedure in a coupon providing system according to the first exemplary embodiment of the present invention.

Referring to FIG. 5, in operation 1101, a user may execute an application for a personal customized coupon providing service provided on the user terminal 100, and according to execution of the application, modules shown in FIG. 3 operate, so that the user terminal 100 may interwork with the coupon providing server 300.

To this end, the user terminal 100 receives an application (that is, an execution program) for a personal customized coupon providing service including the program module shown in FIG. 3 from the coupon providing server 300 and installs the received application, and according to execution of the installed application, the user terminal 100 accesses the coupon providing server 300 to transmit an information request message and receive an information request responding message.

Thereafter, in operation 1102, the user terminal 100 may receive real-time position information. That is, the user terminal 100 collects current position information in real time at a predetermined period of time through the position information collecting module 110 and stores the collected current position information.

In addition, in operation 1103, the user terminal 100 may collect and store utilization information of the user about using a product or service (for example, purchase details) through the utilization information collecting module 120. The utilization information may be collected whenever purchase of a product or service occurs or periodically.

Subsequently, in operation 1104, the user terminal 100, if it is determined that position information is maintained for a predetermined period of time based on collected pieces of position information, extracts the position information as a main residential area and extracts an overlapping travel path among travel paths of the collected pieces corresponding to position information as a main travel path, and store position information according to the extracted main residential area and the extracted travel path. For example, the main residential area may be a company, a school and a house, and the main travel path may be a path along which the user goes to a school or a path along which the user goes to work. In addition, the user terminal 100 may extract a trading area in which the user uses a product or service, based on utilization information about the user.

Thereafter, in operation 1105, the user terminal 100 determines a possibility of purchase by comparing the current position information collected in real time with the stored information about the main residential area and main travel path, and determines an event-identification target according the determined possibility of purchase. For example, when a current position deviates from the main residential area and the main travel path, the current position corresponds to a place that hasn't been visited by the user, and thus, the current position information is determined as an event-identification target. On the other hand, when the current position does not deviate from the main residential area and the main travel path, it is determined that there is a strong possibility of a previously used affiliated store being used again, and thus utilization information about using an affiliated store around the current position is determined as an event-identification target.

Then, in operation 1106, the user terminal 100 transmits an information request message to request coupon information to the coupon providing server 300. In this case, the information request message may include the current position information or utilization information determined as an event-identification target.

In operation 1107, the coupon providing server 300 extracts position information or utilization information about the user from the received information request message, and searches for coupon and event information related to the extracted position information or extracted utilization information about the user. In this case, the coupon providing server 300 refers to for information about an affiliated store related to the extracted position information or extracted utilization information about the user, searches for a coupon available in the referred affiliated store and generates an information request responding message such that coupon information is arranged for each affiliated store.

Thereafter, in operation 1108, the coupon providing server 300 transmits the information request responding message including the coupon information to the user terminal 100.

Then, in operation 1109, the user terminal 100 receives the information request responding message transmitted from the coupon providing server 300, and outputs the coupon information included in the information request responding message. In this case, the coupon information may be processed in the form easy to be recognized by a user through the user interface module 140 and output. For example, the coupon information may be generated into a list for each affiliated store and output.

Meanwhile, the setting of the main residential area and the main travel path according to the first exemplary embodiment of the present invention has been described in relation that the user terminal 100 collects position information in real time and extracts a main residential area and a main travel path based on the collected position information. However, the present invention is not limited thereto, and the main residential area and the main travel path may be set by a user's direct input.

Hereinafter, a method for a personal customized coupon providing service in a user terminal and a coupon providing server according to the above described procedure for the personal customized coupon providing service will be described in detail.

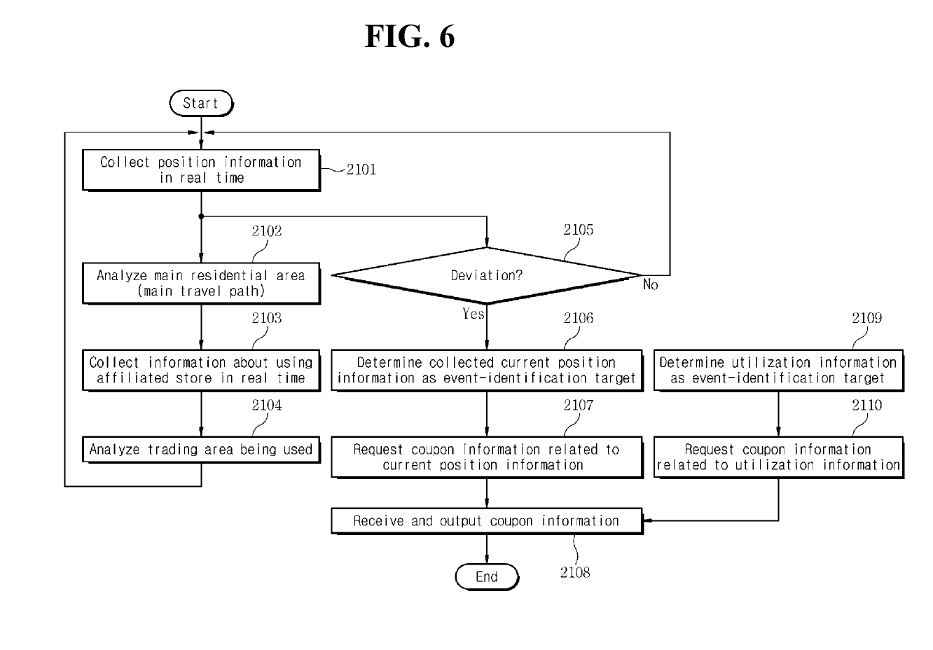

FIG. 6 is a view showing a method of providing a coupon in a user terminal of a coupon providing system according to the first exemplary embodiment of the present invention.

Referring to FIG. 6, the user terminal 100 executes an application for a personal customized coupon providing service, executing operation 2101 first.

In detail, in operation 2101, the user terminal 100 may collect position information according to movement of a user in real time or periodically.

Subsequently, in operation 2102, the user terminal 100 extracts a main residential area and a main travel path based on the collected position information and stores the extracted information. For example, the user terminal 100, if it is determined that position information is maintained for a predetermined period of time based on position information collected for a predetermined time and period, extracts the position information as a main residential area, and extracts a travel path whose position information overlaps among the collected pieces of position information as a main travel path and stores the extracted main residential area and the extracted main travel path. The main residential area may be a company, a school and a house, and the main travel path may be a path along which the user goes to a school or goes to work.

Thereafter, in operation 2103, the user terminal 100 collects information of a user about using nearby affiliated stores, and in operation 2104, analyzes a trading area mainly used by the user based on the collected information.

Operations 2101 to 2104 may be repeatedly performed to accumulate position and utilization information about the user, and based on the accumulated information, the main residential area/the main travel path/the trading area in use may be more precisely analyzed.

Meanwhile, in operation 2105, the user terminal 100, whenever position information is collected, may check whether the collected current position deviates from the stored main residential area and main travel path based on the collected position information and the stored main residential area and main travel path.

If it is determined as a result of comparing the collected position information with the main residential area and the main travel path, that the collected current position deviates from the main residential area and the main travel path (Y), the user terminal 100 may determine the corresponding position as an event-identification target in operation 2106. Meanwhile, if it is not determined as deviation (N), the user terminal 100 keep collecting real-time position information in operation 2102.

Subsequently, in operation 2107, if the collected position information is determined as an event-identification target, the user terminal 100 transmits an information request message including the collected position information to the coupon providing server 300 to request coupon and event information related to the collected position information.

Then, in operation 2108, the user terminal 100 receives an information request responding message transmitted from the coupon providing server 300, and outputs coupon information included in the information request responding message.

Meanwhile, if it is determined as a result of comparing the collected position information with the main residential area and the main travel path, that the collected current position does not deviate from the main residential area and the main travel path (N), in operation 2109, the user terminal 100 may determine utilization information collected around the current position as an event-identification target, and in operation 2110, transmits an information request message including the utilization information, which is an event-identification target, to the coupon providing server 300 to request coupon and event information related to the collected position information.

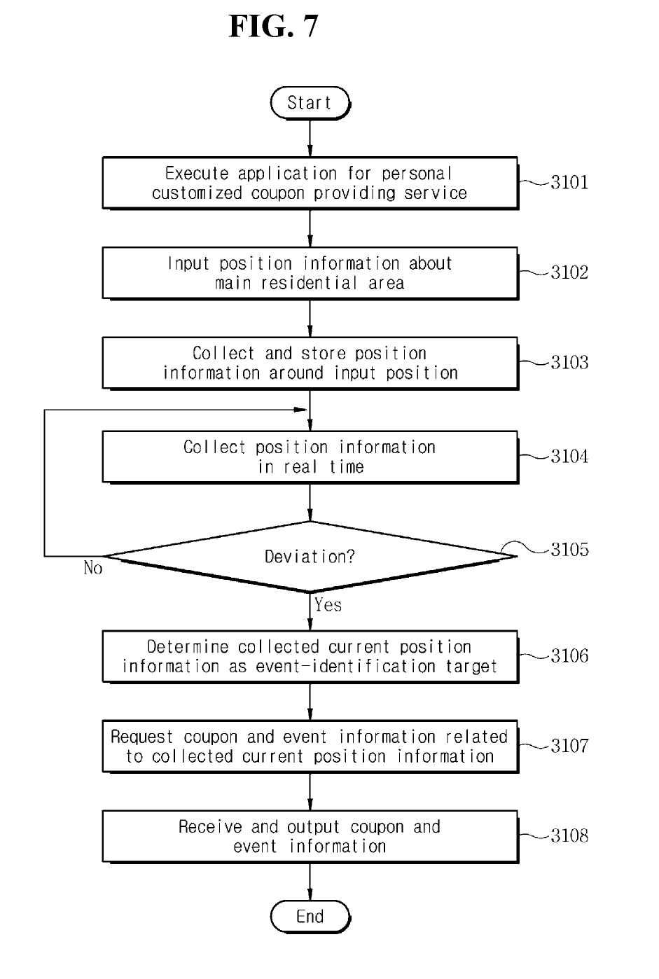

FIG. 7 is a view showing another example of a method of providing a coupon in a user terminal according to the present invention. Since configuration of the method of providing a coupon in a user terminal shown in FIG. 7 is identical to that shown in FIG. 6 except for a configuration of acquiring position information about a main residential area, detailed description thereof will be omitted and only a configuration of acquiring position information about a main residential area is described in detail.

Referring to FIG. 7, in operation 3101, the user terminal 100 may execute an application for a personal customized coupon providing service. As the application is executed according to a user's manipulation, an input screen in which position information about a main residential area can be input is displayed on an output unit.

In operation 3102, the user terminal 100 may input a main residential area (a main travel path), for example, by inputting a main residential area (a travel path) on the input screen displayed through the user's manipulation, for example, position information (address) of home, company and school or by designating a path between a corresponding point and a point through a map search. To this end, the user interface module 140 may configure and provide a user interface in which a user may designate or input a main residential area and a main travel path.

Thereafter, in operation 3103, the user terminal 100 may collect surrounding position information based on the input position information, and store the collected position information. The stored position information about the main residential area (the main travel path) and the stored surrounding position information may be used to check deviation of subsequently collected position information.

Then, in operation 3104, the user terminal 100 collects position information in real time or periodically, and in operation 3105, compares the collected position information with the stored position information about the main residential area (the main travel path) and the surrounding position information to determine whether the collected current position deviates from the main residential area (the main travel path).

Then, in operation 3106, if it is determined in operation 3105 that the collected current position deviates from the main residential area (the main travel path) (Y), the collected current position information is determined as an event-identification target, and in operation 3107, an information request message including the collected position information is transmitted to the coupon providing server 300 to request coupon and event information related to the collected position information.

Thereafter, in operation 3108, the user terminal 100 receives an information request responding message transmitted from the coupon providing server 300, and outputs coupon and event information included in the information request responding message through the output unit. The coupon and event information may be arranged for each affiliated store and output.

Meanwhile, although not shown in FIG. 7, if it is determined in operation 3106 that the collected current position does not deviate from the main residential area (the main travel path) (N), the user terminal 100 performs operations 2109 to 2110 of FIG. 6 to receive coupon information found based on utilization information.

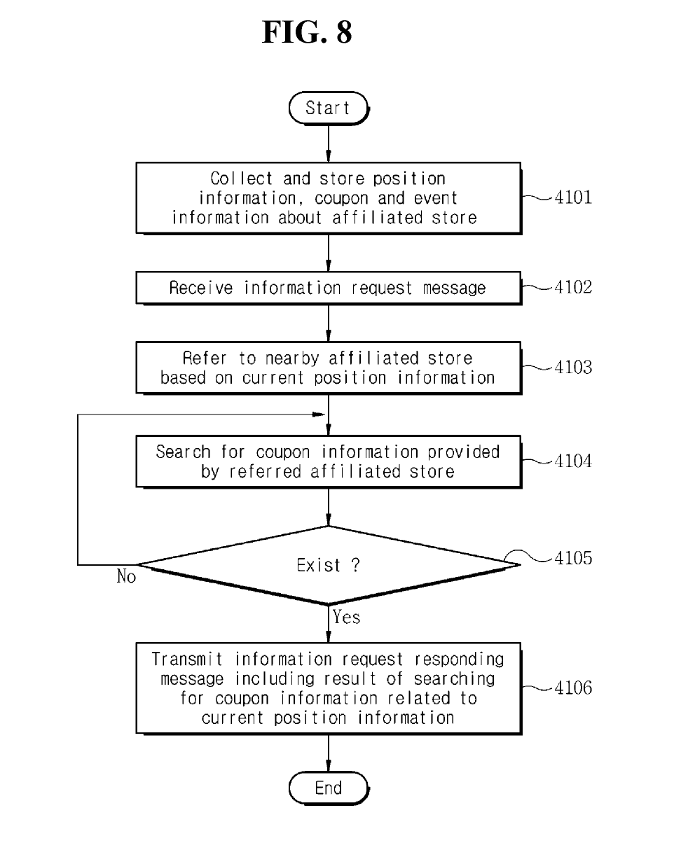

FIG. 8 is a view showing a method of providing a coupon in the coupon providing server 300 according to the present invention.

Referring to FIG. 8, in operation 4101, the coupon providing server 300 collects the position information about the affiliated store, available coupon information and event information in progress from the affiliated store terminal 200 by interworking with the affiliated store terminal 200 via the communication network, and store the collected information.

Then, in operation 4102, the coupon providing server 300 receives an information request message to request coupon and event information related to the current position information from the user terminal 100 by interworking with the user terminal 100 via the communication network. The information request message may include at least current position information. In addition, the information request message may include utilization information (or trading area use information) about an affiliated store around the current position.

Subsequently, in operation 4103, the coupon providing server 300 searches for coupon information to be provided to the user terminal 100 based on the received information request message. To this end, first, the coupon providing server 300 may refer to affiliated stores around the current position based on the current position information included in the information request message. In addition, if utilization information is included in the information request message, the coupon providing server 300 may refer to an affiliated store that has been used by the user, based on the utilization information.

Then, in operation 4104, the coupon providing server 300 may search for coupon information provided by the referred affiliated store.

If it is determined in operation 4104 that coupon and event information provided by the referred affiliated store exist (Y in operation 4105), in operation 4106, the coupon providing server 300 may transmit an information request responding message including the result of searching for the coupon and event information related to the received current position information to the user terminal 100. In this case, the received search result of coupon information related to the current position information and/or utilization information may be arranged and provided such that coupons and events of an affiliated store adjacent to the current position is displayed, or arranged and provided in the order of a short remaining period for use, or provided such that coupons and events are distinguished by business categories.

Hereinafter, a personal customized coupon providing service procedure according to the second exemplary embodiment of the present invention will be described.

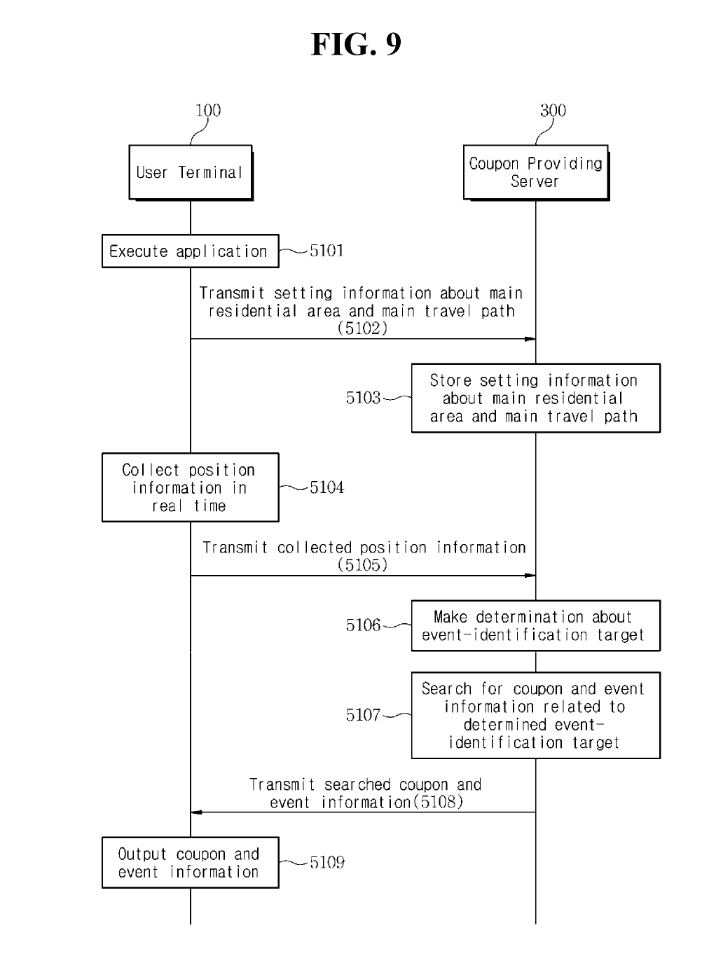

FIG. 9 is a view showing a personal customized coupon providing service procedure in a coupon providing system according to the second exemplary embodiment of the present invention. The personal customized coupon providing service procedure according to the second exemplary embodiment of the present invention is identical to the personal customized coupon providing service procedure according to the first exemplary embodiment of the present invention shown in FIG. 5 in configurations thereof except that a subject who determines an event-identification target with respect to collected position information is the coupon providing server. Accordingly, only a configuration in which the coupon providing server determines an event-identification target with respect to collected position information will be described in detail and descriptions of the same configuration will be simplified or omitted.

Referring to FIG. 9, in operation 5101, the user terminal 100 may execute an application for a personal customized coupon providing service provided in the user terminal 100 according to a user's manipulation. The user terminal 100 may interwork with the coupon providing server 300 through execution of the application.

Then, in operation 5102, the user terminal 100 outputs an input screen, in which position information for setting a main residential area and a main travel path can be input, on a display at an initial execution of the application, and transmits the input setting information about the main residential area and the main travel path to the coupon providing server 300.

Then, in operation 5103, the coupon providing server 300 receives and stores the setting information about the main residential area and the main travel path transmitted from the user terminal 100. The setting information about the main residential area and the main travel information may be position information about the main residential area and the main travel path.

Meanwhile, the coupon providing server 300 may further collect utilization information of a user about using n affiliated store by interworking with the user terminal 100 or an external server (for example, a payment server or a financial institution server).

Then, in operation 5104, the user terminal 100 collects real-time position information, and in operation 5105, transmits an information request message including the collected position information to the coupon providing server 300.

In operation 5106, the coupon providing server 300 determines whether the position information received based on the position information included in the information request message transmitted from the user terminal 100 and the stored setting information about the main residential area and the main travel path is an event-identification target. That is, the coupon providing server 300 compares the collected position information with the position information corresponding to the setting information about the main residential area and the main travel path, and if it is determined as deviation, determines the collected position information as an event-identification target, and if it is not determined as deviation, determines utilization information about a user generated around the received position information as an event-identification target.

Then, in operation 5107, the coupon providing server 300 searches for coupon and event information related to the event-identification target. That is, if the position information is determined as an event-identification target, the coupon providing server 300 searches for an affiliated store around the current position and coupon information of the searched affiliated store, and if the utilization information is determined as an event-identification target, the coupon providing server 300 searches for an affiliated store around the current position which has been used by a user and coupon information of the searched affiliated store.

Then, in operation 5108, the coupon providing server 300 transmits an information request responding message including the coupon and event information related to the position information about the user to the user terminal 100.

Then, in operation 5109, the user terminal 100 receives the information request responding message transmitted from the coupon providing server 300, and outputs coupon information included in the information request responding message.

Hereinafter, a detailed method for a personal customized coupon providing service in the user terminal and the coupon providing server according to the personal customized coupon providing service procedure described above will be described.

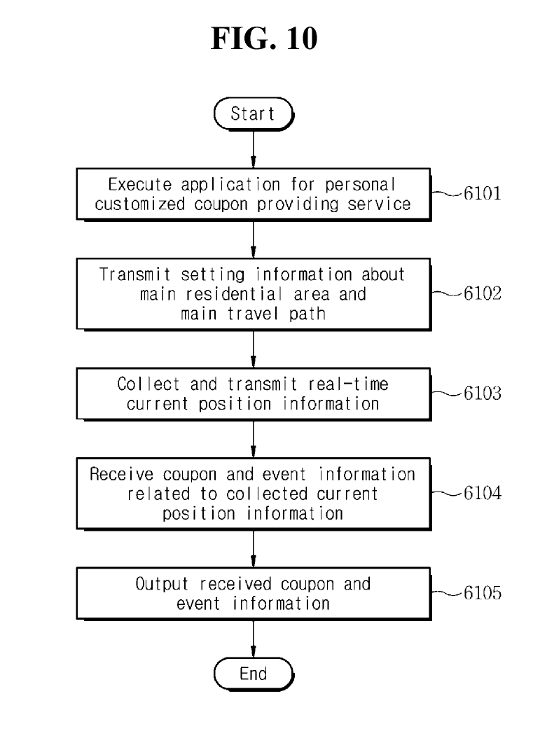

FIG. 10 is a view showing a method of providing a coupon in the user terminal 100 of the coupon providing system according to the second exemplary embodiment of the present invention.

Referring to FIG. 10, in operation 6101, the user terminal 100 may execute an application for a personal customized coupon providing service. As the application is executed according to a user's manipulation, the user terminal 100 may display an input screen in which position information about a main residential area and a main travel path can be input on an output unit.

In operation 6102, the user terminal 100 inputs the position information about the main residential area and the main travel path, thereby transmitting setting information about the main residential area and the main travel path to the coupon providing server 300. For example, the user terminal 100 may input position information about a main residential area and a main travel path by inputting position information (address) and travel path with respect to home, company and school on the input screen displayed through the user's manipulation or by designating a corresponding position through a map search.

Thereafter, in operation 6103, the user terminal 100 may collect real-time position information and transmit the collected real-time position information to the coupon providing server 300.

Then, in operation 6104, the user terminal 100 may receive coupon information related to the current position information collected from the coupon providing server 300 via the communication network.

Then, in operation 6105, the user terminal 100 may output received coupon and event information.

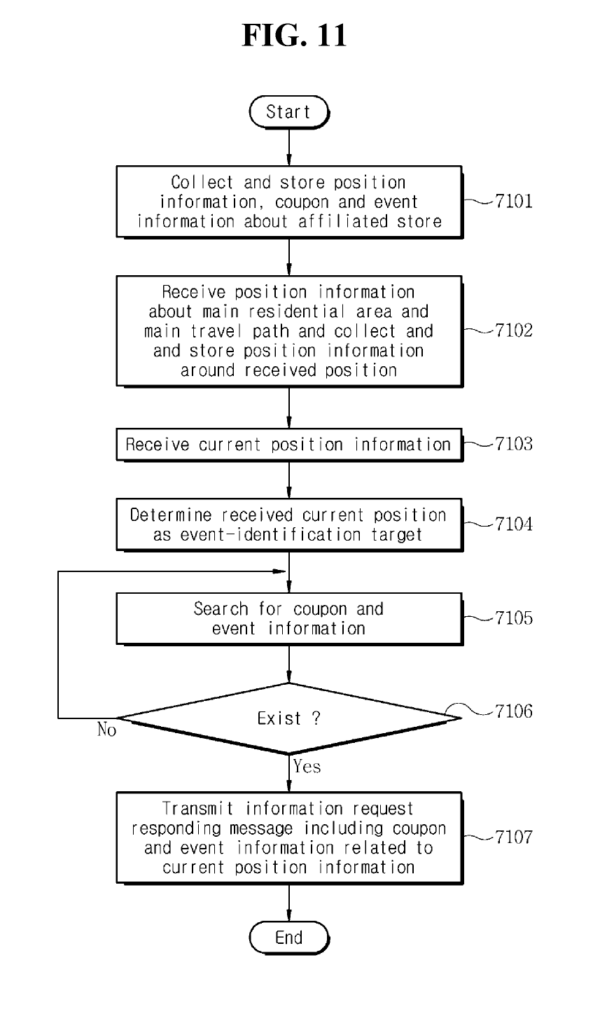

FIG. 11 is a view showing a method of providing a coupon in the coupon providing server 300 according to the second exemplary embodiment of the present invention.

Referring to FIG. 11, in operation 7101, the coupon providing server 300 collects the position information about the affiliated store, available coupon information and event information in progress from the affiliated store terminal 200 by interworking with the affiliated store terminal 200 via the communication network, and store the collected information. In addition, the coupon providing server 300 may collect utilization information (payment details) about affiliated stores of a user by interworking with the user terminal 100 or an external server.

In addition, in operation 7102, the coupon providing server 300 receives position information about a main residential area and a main travel path transmitted from the user terminal 100, and collects and stores position information around the received position.

In operation 7103, the coupon providing server 300 may receive current position information that is collected in real time from the user terminal 100.

In operation 7104, the coupon providing server 300 makes a decision about an event-identification target by checking whether the received current position information is new position information based on the received current position information and the stored position information about the main residential area and the main travel path. In detail, the coupon providing server 300 compares the collected position information with the position information corresponding to the setting information about the main residential area and the main travel path, and if it is determined as deviation, determines the collected position information as an event-identification target, and if it is not determined as deviation, determines utilization information about a user generated around the received position information as an event-identification target.

Then, in operation 7105, the coupon providing server 300 searches for coupon and event information related to the received current position information and/or the utilization information. That is, the coupon providing server 300 refers to an affiliated store around the received current position or refers to an affiliated store around the current position which has been used by a user, and searches for coupon information and event information in progress in the referred affiliated store.

Then, if coupon and event information related to the received current position information is found to exist in operation 7106, the coupon providing server 300 in operation 7107 transmits an information request responding message including the coupon and event information related to the received current position information to the user terminal 100 via the communication network.

Meanwhile, if coupon and event information related to the received current position information is not found to exist in operation 7106, the coupon providing server 300 performs operation 7106 such that relevant coupon and event information are searched in a surrounding area expanded based on the received current position information.

The specification includes details of a number of specific implements, but it should be understood that the details do not limit any invention or what is claimable in the specification but rather describe features of the specific embodiment. Features described in the specification in the context of individual embodiments may be implemented as a combination in a single embodiment. In contrast, features described in the specification in the context of a single embodiment may be implemented in multiple embodiments individually or in an appropriate sub-combination. Furthermore, the features may operate in a certain combination and may initially described as claimed in the combination, but one or more features may be excluded from the claimed combination in some cases, and the claimed combination may be changed into a sub-combination or a modification of a sub-combination.

Similarly, even though operations are described in a certain order on the drawings, it should not be understood that the operations be executed in the certain order or in a sequential order to obtain desired results, or that all the operation be executed. In some cases, a multitasking and a parallel processing may be beneficial. In addition, it should not be understood that the separation of various system components in the above described embodiments is required in all embodiments, and it should be understood that the above described program components and systems may be incorporated into a single software product or may be packaged in multiple software products.

Hereinbefore, embodiments of the subject matter in the specification have been described. Other embodiments are within the scope of the following claims. For example, suitable results may be achieved even if operations cited in the claims are performed in a different order. For example, the process shown in the appended drawings does not necessarily require the illustrated order or a sequential order. In a certain embodiment, a multitasking and a parallel processing may be beneficial.

The description suggests the best mode of the present invention to provide an example that explains the present invention and also enables one skilled in the art to manufacture and use the present invention. The specification drafted as such is not limited to detailed terms suggested in the specification. Accordingly, it will be apparent to those skilled in the art that various modifications, changes, and variations may be made in the example without departing from the scope of the invention.

Accordingly, the scope of the present invention should be defined not by the embodiments but by the claims.

The present invention determines a possibility of purchase at the current point of time based on information about a user about using an affiliated store and information about a current position of the user, and provides a coupon based on the current position of the user according to the possibility of purchase, thereby providing the user with an optimized coupon at the current point of time and the current position of the user, and thus supporting an effective purchase of the user.

In addition, the present invention provides a coupon to a user who is high likely to use an affiliated store, so that waste of recourse and degradation of reliability of customers due to undiscriminating dispatch of coupons can be prevented and a possibility of a coupon being used can be increased, thereby inducing a user to use a corresponding affiliated store, leading to increase in the sales of the affiliated store.

In this specification, exemplary embodiments of the present invention have been classified into the first, second and third exemplary embodiments and described for conciseness. However, respective steps or functions of an exemplary embodiment may be combined with those of another exemplary embodiment to implement still another exemplary embodiment of the present invention.

What is claimed is:

1. A coupon proving server comprising:
a storage module configured to store position information about a main residential area of a user and position information about a main travel path of the user, information of the user about using an affiliated store, information about a coupon usable at each affiliated store and information about an event being in progress at each affiliated store;
a user information collecting module configured to collect real-time position information about the user, position information about a main residential area of the user, position information about a main travel path of the user and utilization information of the user about using an affiliated store;
an event processing module configured to, upon receiving an information request message including current position information about the user from the user, compare the current position information with the main residential area and the main travel path, and if it is determined that the user is out of the main residential area and the main travel path, determine that the current position information as an event-identification target; and
a coupon service module configured to, in response to the information request message, search for coupon information of an affiliated store related to the current position determined as the event-identification target, generate an information request responding message including the searched coupon information and provide the user terminal with the generated information request responding message.

2. The coupon proving server of claim 1, wherein:
the event processing module compares the current position information with the main residential area and the main travel path, and if it is determined that the user is not out of the main residential area and the main travel path, determines the utilization information of the user related to the current position information as an event-identification target; and
the coupon service module searches for coupon information of an affiliated store that is related to the current position information and has been used by the user, based on the utilization information.

3. A method for customized coupon providing service, the method comprising:
collecting position information about a user in real time or periodically;
extracting and storing information about a main residential area and a main travel path of the user based on the collected position information;
checking whether a current position of the user deviates from the main residential area and the main travel path by comparing the current position information of the user with the main residential area and the main travel path; and
sending a coupon providing apparatus an information request message to request coupon information related to the current position information if it is determined that the collected current position deviates from the main residential area and the main travel path.

4. The method of claim 3, further comprising:
collecting information of the user about using affiliated stores; and
sending the coupon providing apparatus an information request message to request coupon information related to utilization information related to the current position information if it is determined that the collected current position does not deviate from the main residential area and the main travel path.

5. A method for a customized coupon providing service, the method comprising:
collecting position information about an affiliated store, information about a coupon usable in the affiliated store and information about an event being in progress in the affiliated store from one or more affiliated store terminals and storing the collected information;
setting a main residential area and a main travel path of a user;
receiving an information request message including current position information from one or more user terminals;
comparing the received current position information with the main residential area and the main travel path, and determining the received current position information as an event-identification target if it is determined that the current position deviates from the main residential area and the main travel path;
searching for coupon information of an affiliated store around the current position that is determined as the event-identification target; and
transmitting an information request responding message including the searched coupon information to the one or more user terminals.

6. The method of claim 5, further comprising:
collecting information of a user about using affiliated stores;
comparing the received current position information with the main residential area and the main travel path, and determining utilization information related to the received current position information as an event-identification target if it is determined that the user has not deviated from the main residential area and the main travel path; and
searching for coupon information of an affiliated store that is related to the received current position information and has been used by the user, based on the utilization information that is determined as the event-identification target.

7. The method of claim 5, wherein in the setting of the main residential area and the main travel path, a main residential area and a main travel path of the user are extracted by analyzing position information having been collected from the user terminal for a predetermined period of time.
